(19) United States
(12) Patent Application Publication
(10) Pub. No.: US 2008/0229278 A1
(43) Pub. Date: Sep. 18, 2008

(54) Component-based development

(75) Inventors: Xiaodong Liu, Edinburgh (GB); Colin Combe, Edinburgh (GB); Beihu Wang, London (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: The Court of Napier University

(21) Appl. No.: 11/786,311

(22) Filed: Apr. 10, 2007

(30) Foreign Application Priority Data
Feb. 13, 2007 (GB) 0702742.8

(51) Int. Cl. G06F 9/44

(52) U.S. Cl. 717/106

(57) ABSTRACT

A method is provided for adapting a software component. The method includes the steps of extracting a component specification comprising binary code and metadata from a first component; creating a context-oriented adaptation specification; adapting at least part of the first component in accordance with the context-oriented adaptation specification and an adaptation rule; and generating an adapted component on the basis of the adapted and un-adapted parts of the first component. A tool is also provided for carrying out these steps and may be part of a computer program.

### FIELD OF THE INVENTION

The present invention relates to component-based development (CBD) and in particular to new ways of adapting components for use between different contexts.

### BACKGROUND

Over the last decade, many development teams in the IT industry have moved to a revolutionary software development process called Component-Based Development (CBD) as this process can reduce the development cost in both time and money dramatically. CBD involves the design and construction of computer-based systems with reusable software components, which are developed by the same team or a third party company as an asset to encapsulate their previous development expertise and knowledge. CBD shifts the emphasis from programming software to composing software systems.

A “component” is interpreted as a code portion or a part of a programme that is reusable in various software systems. A component is specified by its interface characteristics, which may include the syntax of the component, operational or logical constraints, or behaviour of the component. The data that defines the interface characteristics is known as a “component specification”. The component specification gives knowledge of a component's characteristics and suitability for various different contexts or use-case scenarios.

One obstacle of component reuse and smooth system composition is the high variability of reuse context. The context for which a component is to be used is taken herein to be specified by the type of data model, the architecture in which the component is to be placed and the application speciality of its intended use. The term “context” is to be distinguished from a more simple use-case scenario, which is specified merely by the type of application for which the component is to be used.

The rationale of CBD is that a component is an independent reuse unit for the construction of an application. However, at present there are not many components that can be actually reused without being adapted. The problem is caused by for example, incomplete component specifications, the mismatches between components and the reuse context including the application architecture, required functionality, software and hardware environments, quality attributes and other collaborating components. To tackle this problem, it is desirable to provide an automated deep component adaptation technology. “Deep” adaptation is understood to mean an adaptation of the structure of a component, that is, an adaptation that goes beyond a simple conversion of the inputs to or outputs from the component that treats the component as a “black box” with no knowledge of the functionality of the component.

Various adaptation technologies have been proposed. The first of these is commonly referred to as “component customisation” and is suitable for simple level adaptation. End-users customise a software component by choosing from a fixed set of options that are already pre-packaged inside the software component. A component should be customisable during the reuse to fit itself into specific real-world requirements. It is obvious that component customisation is a useful activity in the overall component reuse process and those components need to have a set of specific built-in services to facilitate customisation.

In another adaptation technology, called Active Interface, a component interface is defined by a set of ports. This interface must play a greater role in helping software developers to adapt the component. An active interface for a component can be programmed to take action when a method is invoked. As a port is associated with a set of methods, each method request is a port request as well. The internal component interface consists of private and protected methods. Although private to the component, these internal methods are able to support an active interface and can have their own before-phase and after-phase. However, revealing the internal interface of a component in this way does not reveal its implementation.

The active interface mechanism, as described, is limited to adapting the behaviour of a component at the standard interface boundaries. In general, a component designer can create special ports that allow policy decisions on the component to be adapted. In this way, the interface for the component is augmented, as in the known Open Implementation (proposed by Xerox Corporation's Palo Alto Research Centre (PARC)), to enable key decisions to be adapted. The adaptation technique of active interfaces is supported by the internal adaptation mechanism of a component arbitrator. Such an arbitrator can be easily integrated into any component.

A further popular adaptation technology for component reuse has been component wrappers. For example, the Microsoft .NET framework provides a wrapper tool (COM Wrapper) for developers to wrap a former Windows component for the use in .NET environment. Although suitable for certain situations, a component wrapper incurs heavy code overhead in adapted components and often degrades the adapted components and the target system. Moreover, a component wrapper can only adapt the interface of a component to a very limited extent.

The present inventors have previously proposed an adaptation technology as described in the paper “Achieving seamless component composition through scenario-based deep adaptation and generation” Xiaodong Liu, Beihu Wang, Jon Kerridge, Science of Computer Programming 56 (2005) 157-170. This paper proposed a use-scenario based component adaptation and generation technique to achieve deep adaptation through an XML based component specification, interrelated adaptation scenarios and corresponding component adaptation and generation. A taxonomy of component adaptation types was developed and propagation relationships were defined in order to govern the generation of components. This approach promises some reduction in the code overhead for component adaptation, but its application is limited by the nature of use-case scenarios.

Accordingly, there is still a need for improvements in the field of CBD.

### SUMMARY OF THE INVENTION

According to a first aspect of the present invention there is provided a method of adapting a software component comprising:

extracting a component specification comprising binary code and metadata from a first component;

creating a context-oriented adaptation specification;

adapting at least part of the first component in accordance with the context-oriented adaptation specification and an adaptation rule; and

generating an adapted component on the basis of the adapted and un-adapted parts of the first component.

Preferably, the method further comprises the step of creating an adaptation rule.

Preferably, the adaptation rule is chosen from a selection of predetermined adaptation rules.

Preferably, said adaptation rule is automatically triggered when a chosen adaptation is required; and said adaptation rule performs an adaptation algorithm to yield one or more resultant adaptations.

Preferably, said adaptation algorithm is stored in a repository and is called by the adaptation rule.

Preferably, the first component is selected according to a pre-qualification process depending on system requirements including system architecture, functionality and quality attributes.

Preferably, the adaptation rules are selected from a repository.

Preferably, the repository has an open structure.

Preferably, adaptation rules are created on the basis of programming knowledge on CBS and components or from application domain knowledge.

Preferably, component adaptation rules are bound into binary classes of component adaptation rule objects.

Preferably, the step of adapting a component is checked against healthiness conditions which a component must meet for correct operation.

Preferably, an alert is generated to a software developer/user if a healthiness condition is breached by a proposed adaptation.

Preferably, healthiness conditions are created on the basis of programming knowledge on CBS and components or from application domain knowledge.

Preferably, a dependency graph is generated which illustrates the effects of an adaptation on other components or on other parts of the same component.

Preferably, the generated adapted component is validated against the proposed context-oriented adaptation specification before being finally approved for use.

Preferably, the method is adapted for a .NET platform.

Preferably, the component specification comprises the component's IL code and metadata.

Preferably, a sketch of the first component is created with the types, classes and method signatures of the first component but with empty method bodies.

Preferably, adaptation rule objects are applied to adapt the bodies of the relevant methods of adapted components.

Preferably, an adapted component sketch is integrated with adapted or inserted method body or pieces of body in order to create the adapted component.

Preferably, the method is adapted for a JAVA platform.

Preferably, component adaptation is carried out at source code level.

Preferably, both the extracted and the adapted component specification is in XML format.

Preferably, component adaptation is carried out at binary code level.

Preferably, the component specification comprises the component's JVM binary code and Java metadata.

Preferably, the component specification comprises an outline specification of the component's structure and interface.

Preferably, Java Byte Code Engineering Library used to adapt the component's binary code according to adaptation rule instances specified in the context-oriented adaptation specification.

According to a second aspect of the invention, there is provided a tool for generating an adapted component comprising:

means for extracting a component specification from a first component;

means for creating and/or editing a context-oriented adaptation specification;

means for adapting at least part of the first component in accordance with the context-oriented adaptation specification and an adaptation rule;

means for generating an adapted component on the basis of the adapted and un-adapted parts of the first component.

Preferably, the tool further comprises an adaptation rule extractor for the creation and editing of adaptation rules.

Preferably, the tool further comprises an open-structured adaptation rule repository.

Preferably, the tool further comprises a class library generator for automatically generating the class library of the adaptation rule repository.

Preferably, the tool further comprises a component specification (CS) viewer tool for navigating the structure of the component.

Preferably, the CS viewer tool displays dependency graphs showing interdependencies among components and/or adaptation rule instances.

Preferably, the tool is adapted for the performance of the method of the first aspect.

According to a further aspect, there is provided a computer program product comprising the tool of the second aspect.

### BRIEF DESCRIPTION OF THE DRAWINGS

The present invention will now be described, by way of example only, with reference to the accompanying drawings in which:

FIG. 1 illustrates the process of context-oriented rule-driven generative component adaptation approach in accordance with an aspect of the present invention;

FIG. 2 illustrates the system architecture of the component adaptation tool, which realises and automates the adaptation mechanism in accordance with an aspect of the present invention;

FIG. 3 illustrates the realisation of the practical generative component adaptation process in .NET framework in accordance with an aspect of the present invention;

FIG. 4 illustrates the realisation of the practical generative component adaptation process Java platform in accordance with an aspect of the present invention; and

FIG. 5 illustrates the adaptation rule repository and the automatic binding and application of the adaptation rules in accordance with an aspect of the present invention.

### DESCRIPTION OF THE PREFERRED EMBODIMENTS

Methods and apparatus will now be disclosed that facilitate and conduct generative component adaptation with no or little code overhead in the components and no degradation to the target component-based systems.

Three key techniques have been developed: context oriented adaptation specification (COAS), automated adaptation rules together with a corresponding open structured repository, and a rule driven component adaptation and generation engine.

The component adaptation and generation can comprise a separate component adaptation engine and component generation engine. Both of these engines can be integrated into the same tool while still performing logically separate functions. They will usually be illustrated as separate components as the diagrams used with the present application are intended as logical schematics rather than representations of the physical structure of any given system. Thus, references to a “component adaptation and generation engine” will in general imply a reference to either or both of an adaptation or a generation function, unless the context of the description indicates otherwise.

‘Rules’ govern the automation of the process; they assist in the process of composing the COAS. Rules are stored in an open structured repository that allows the developer to refine and add to them. A rule comprises an inference, that is, they it has the general structure “A implies B”. However, in this context the rules differ slightly from inference rules as used in other areas of software engineering, such as business rules engines, because here, a rule may also require that the user be prompted to confirm the outcome.

Rules may be based on common programming knowledge or on knowledge drawn from the domain area the developer is working in. Rules based on common programming knowledge will be applicable across domains, but may still be refined or added to by a particular developer.

An adaptation rule comprises three main aspects. Firstly, a specific adaptation is defined that triggers the application of the rule. When that adaptation is input as a required adaptation, the rule is automatically triggered. Secondly, an adaptation algorithm describes the consequences that the required adaptation may have on a component. Thirdly, the adaptation rule describes a set of resultant adaptations that result from the application of the rule.

The required and resultant adaptations are described using the same XML syntax as is used to store the list of adaptations that makes up the COAS itself.

In one embodiment, the adaptation algorithm to use is not entirely specified as part of the adaptation rule, but is rather stored in a repository. The rule comprises the name of the adaptation algorithm to be called from the repository, along with any parameters it requires and whether or not the user should be prompted to confirm the addition of the each of the triggered adaptations. Adding new algorithms will require manual coding, but the system can be designed to help facilitate this. The general intention is that the same algorithm can be used for many different rules.

When a developer starts using the tool it will already contain a set of commonly used algorithms (and a set of rules based on programming knowledge). Many of the algorithms will utilise a dependency graph of the component(s) being used as sources, this is a model of the structure of the component(s) constructed by the tool (see below).

The following is an example of how a rule is defined, in this case, for a piece of programming knowledge.

### EXAMPLE

The tool may allow modification of the accessibility/visibility of methods within a component. A programmer may wish to restrict the visibility of a method in the process of reengineering a component. We know that if you restrict access to a method by making it private then all external calls to that method will have to be removed. This knowledge can be captured as a rule. The first aspect of the rule is as follows:

```
<RequiredAdaptation>
  <ModifyMemberAccess>
    <TypeName>*</TypeName>
    <MemberName>*</MemberName>
    <MemberAccess>Private</MemberAccess>
  </ModifyMemberAccess>
</RequiredAdaptation>
```

A modification that matches the contents of the ‘RequiredAdaptation’ tags will trigger the application of the rule (the asterisk is a wildcard in terms of matching but also denotes that the values in these spaces are needed as input to the algorithm to be used). The following describes the algorithm to use and the set of adaptations that the rule triggers:

```
<Algorithm prompt=“true”>
  <ForEachMethodInBackwardSlice scope=“external”>
    <RemoveMember>
      <TypeName>TYPENAME</TypeName>
      <MemberName>METHODNAME</MemberName>
    </RemoveMember>
  </ForEachMethodInBackwardSlice>
</Algorithm>
```

‘ForEachMethodInBackwardsSlice’ is the name of the algorithm and this algorithm has an additional parameter called ‘scope’. This is one of the algorithms based on the use of a dependency graph. Multiple ‘TYPENAME’ and ‘METHODNAME’ pairs are the output from the algorithm and these are used to construct the resulting adaptations. So, whilst composing the COAS, if method access is restricted then the tool will know that external methods that call this method should be removed. If the algorithm's prompt attribute is set to true then the user will be prompted to confirm these additional changes.

### End Example

There are two types of adaptation rules: atomic adaptation rules and composite adaptation rules. A set of atomic adaptation rules have been developed based on the extracted programming knowledge on components and component-based systems. Composite adaptation rules are a composition of atomic adaptation rules to support domain-specific adaptation. Composite rules accommodate business domain knowledge, and result in user-expandable adaptation rule repository, support reuse of adaptation knowledge in specific business areas.

Atomic Rules

Syntax:

```
If requires “...” adaptation then
Defines value of
      { ...}
      { ...}
    Triggers adaptation algorithms
      { .. }
  XML implementation:
  <Current adaptation>
    <Defined value>
      ...
    </Defined value>
  </Current adaptation>
  <Algorithm>
    <Triggered adaptations>
        ...
      </Triggered adaptations>
      <Specific healthiness conditions>
        ...
      </Specific healthiness conditions>
  </Algorithm >
  Composite rules
  XML implementation:
  <Applicable adaptation context>
        ...
  </ Applicable adaptation context>
  <Adaptation rules to apply>
      <Atomic adaptation rule 1>
        ... ...
      </Atomic adaptation rule 1>
      < Atomic adaptation rule 2>
        ... ...
      </Atomic adaptation rule 2>
        ... ...
      <Atomic adaptation rule n>
        ... ...
      </Atomic adaptation rule n>
  </Adaptation rules to apply>
```

Computable programming knowledge on components and component-based systems, covering their system architecture and characteristics, are extracted and applied in a new CBD tool as either adaptation algorithms or adaptation rules to automate the generative component adaptation process. In this way, component adaptation knowledge can be reused as well as the component itself. Adaptation knowledge is captured with adaptation rules and adaptation algorithms. Adaptation algorithms control the overview adaptation process and are built in the component adaptation and generation engine. Adaptation rules are the abstraction of specific adaptation knowledge. Instantiated within a particular adaptation context, an adaptation rule may coin out a number of adaptation rule instances, each of which is a case of reuse of the adaptation rule.

High level programming knowledge, which deals with the overall control of the generative adaptation process, is modeled into adaptation algorithms and used by a component adaptation and generation engine, whilst low level more specific knowledge is extracted into abstraction rules.

An extensible adaptation rule repository is set up to accommodate reusable adaptation rules. Application domain knowledge may also be modeled as adaptation rules and stored in the adaptation rule repository. The repository acts as a means to support the reuse of typical existing adaptation knowledge. The repository has an open structure and can accommodate newly developed adaptation rules. An auto binding and application technique is designed to automatically bind component adaptation rules and their instances into component adaptation and generation engine at run time. Any update in the component adaptation rule repository will trigger rebinding of the adaptation rule repository so that consistency is maintained.

A set of healthiness conditions is developed as necessities to guarantee the validity of the adapted components, for example, to keep the consistency of the components at functional and non-functional aspects. A set of healthiness conditions is developed as necessities to guarantee the validity of the adaptation. A healthiness condition can never be violated during adaptation. A dependency graph is derived, among the elements of a component including its types, methods and sub-components. According to the dependency and healthiness conditions, the mechanism decides whether an adaptation rule instance is valid to execute, and whether further adaptation rules will be triggered so that consistency of the affected parts of the component and other related components is maintained.

An approach is for generatively adapting pre-qualified components to eliminate the found mismatches between the components and a particular reuse context first comprises the composition of a context-oriented adaptation specification (COAS) according to the adaptation requirements and extracted component specification (CS). The COAS comprises the adaptation context including the environment, required functionality and quality attributes, and its solution as a set of interrelated adaptation rule instances. The component adaptation engine works by taking COAS as its input. A COAS is the fundamental controlling document through the whole working process of the component adaptation and generation. A COAS can be implemented as XML schema, for example:

```
<COAS>
  <Aimed context>
    Context definition in text or ontological language
  </Aimed context>
  <Adaptation rules to be applied>
    <Instance of adaptation rule 1>
    ... ...
    </Instance of adaptation rule 1>
    < Instance of Adaptation rule 2>
    ... ...
    </Instance of Adaptation rule 2>
    ... ...
    < Instance of Adaptation rule n>
    ... ...
    </Instance of Adaptation rule n>
</COAS>
```

An adaptation rule instance is instantiated from its adaptation rule selected from the adaptation rule repository by integrating the aimed adaptation context detail. The approach further comprises adapting the component code with an adaptation engine, taking the context-driven adaptation specification as the designated input. Finally the approach comprises the generation of the target component by integrating the adapted part and the primitive unchanged part of the component code.

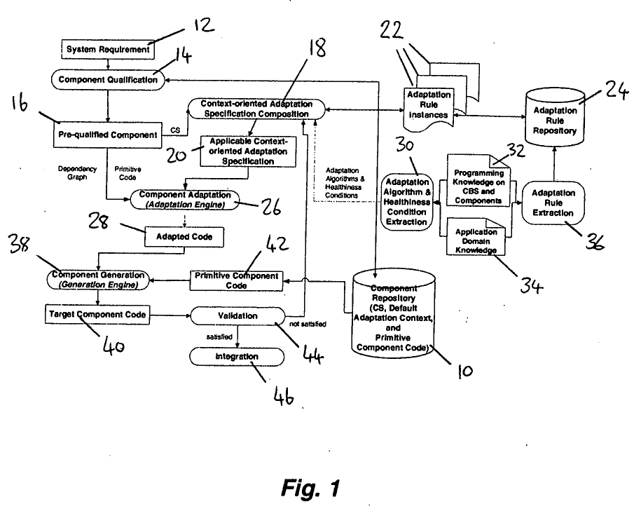

FIG. 1 illustrates an example embodiment of a method and system for component adaptation. A component repository 10 stores reusable components, together with their component specifications (CS), default adaptation contexts and primitive component code. System requirements 12 are input to a component qualification component 14 which interrogates the component repository 10 and selects a component from the repository which conforms to the system requirements. This component is then known as a pre-qualified component 16. The selection of pre-qualified components 16 from the repository 10 is based on the system architecture. The pre-qualified component 16 comprises primitive code, that is, un-adapted code.

To then achieve a high standard or reuse, any mismatches between the pre-qualified components 16 and the current reuse context need to be eliminated. The first step is to define a context oriented adaptation specification (COAS). A COAS composition tool 18 is provided for the interactive collection of adaptation tasks as defined by the application developer. These are recorded together with the reuse context in the COAS object 20. In other words, the COAS comprises the description of reuse context including the required functionality, environment such as software platform and hardware platform, and quality attributes, and a set of interrelated applicable adaptation rule instances 22 (as discussed in more detail below). Adaptation algorithms and healthiness conditions that are extracted from business domain knowledge and programming knowledge of components and CBS are applied during the stage of COAS composition to guarantee the correctness of adaptation and consistency of the adapted component. A component developer can define a number of default adaptation contexts in order to cover typical adaptations. These default adaptation contexts may be used as templates to create new COAS's.

Adaptation rule instances 22 are instantiated from adaptation rules selected from an adaptation rule repository 24, by integrating with the current aimed adaptation context detail. A component adaptation process 26 provided by an adaptation engine (as discussed later) receives the primitive code from the pre-qualified component 16 and the applicable COAS 20 as its inputs and is then used to generate the adapted code 28.

To guarantee the validity of the adapted components (important for ensuring consistency), healthiness conditions are developed from programming knowledge 32 and domain knowledge 34. Healthiness conditions must be met before a component is deemed to have been validly adapted. The adaptation engine that implements the adaptation process 26 is designed to ensure that a healthiness condition is never violated during adaptation.

A dependency graph which illustrates the dependencies among the elements of the component including its types, methods and sub-components is derived by the component adaptation engine that implements the adaptation process 26.

A dependency graph models which parts of a piece of software use which other parts. Their use dates back to 1984 (K. Ottenstein and L. Ottenstein, “The program dependence graph in a software development environment,” in Proceedings of the ACM IGSOFT/SIGPLAN Software Engineering Symposium on Practical Software Development Environments, pp. 177-184, 1984.). At that time, the dominant programming paradigm was procedural programming. As procedural programs consist only of subroutines, the complete dependency graph of a procedural program is equivalent to its call graph.

However, for modern software written using an object-oriented paradigm the situation is more complicated. For example, see the paper ‘The Java system dependence graph’ (Walkinshaw, N. Roper, M. Wood, M. in Proceedings of the Third IEEE International Workshop on Source Code Analysis and Manipulation, 2003.). As described in this paper, the complete dependency graph for a Java program consists of four overlapping types of graph; the method dependence graph (equivalent to a call graph), the class dependence graph, the interface dependence graph and the package dependence graph.

Visualising the dependency graph is a useful way of assisting code comprehension, something which constitutes a significant proportion of the work involved in any software re-engineering task. The tool of the invention may allow the user to view the different aspects of the dependency graph (such as the class dependence graph or the method dependence graph) separately, rather than overloading the user with too much information all at once.

In mathematical terms a dependency graph is a directed graph. Furthermore, the class dependency graph is an acyclic directed graph. A common user interface component already exists for viewing and browsing an acyclic graph, the tree (e.g. the left-hand ‘folders’ panel in windows explorer). If there is any recursion in the software (and there almost certainly will be some) then the method dependency graph will contain cycles and will be less well suited to being displayed as a tree. However, other visualisation techniques exist for cyclic graphs, such as node-link diagrams.

The visual representations of the dependencies will also contain additional information about the type of dependency or whether any modifications have been applied to that part. It will be possible for the user to make some adaptations by interacting directly with the visual representation of the dependency graph.

As mentioned above, two types of domain knowledge have been identified, one based on programming domain knowledge and the other based on domain knowledge of the area the developer is working in (for example, e-business). Dependency graphs are a type of programming domain knowledge but they assist in applying the more abstract rule based adaptation. For example, in the context of ‘adaptation rules’ we might consider a rule that says “When you restrict access to a method by making it private rather than public then all external calls to that method will have to be removed”. The dependency graph allows us to identify where these external calls are located. Furthermore, removing these external calls will itself have repercussions for the parts of the code that made use of them. This is just an example of the type of dependency that can be illustrated.

The dependency graph can therefore be used to warn the user if they are about to break the component, for example, by removing a part that is required by a part that is being kept. The display of the dependency graphs improves “code comprehension”, an important and time-consuming part of any software re-engineering process (including component adaptation). Displaying dependency graphs in the user interface improves user's understanding of the components.

According to the dependency and healthiness conditions, the adaptation process 26 decides whether an adaptation rule instance 22 is valid for execution and whether further adaptation rules 22 will be triggered so that consistency of the affected parts of the component and other related components can be maintained.

The next stage is component generation 38, enabled by an appropriate generation engine as described below. The target component code 40 of the adapted component will be generated based on the combination of the adapted code 28 and the primitive component code 42 as retrieved from the component repository 10. Thereafter, the target component code 40 goes through a validation process 44 to check for its suitability for use against the current reuse context. If the target component code 40 does not fit, the COAS will be refined further to fit, and more suitable components maybe adapted and generated until the application developer is satisfied. At this stage the validated component may be integrated into an application or a larger component 46 which goes through a final test procedure before being released to an end user.

Both the adaptation rule repository 24 and the component adaptation and generation engine have an open structure. Further adaptation rules may be extracted from the business knowledge 34 of application domains or programming knowledge 32 related to components and component-based systems and then populated into the adaptation rule repository 24 through the adaptation rule extractor 30. It is possible to apply high level newly observed programming knowledge 32 or business domain knowledge 34 into the system by modelling the knowledge as new adaptation algorithms and inserting them into the component adaptation and generation engine. The extraction and insertion of adaptation algorithms need much intervention from the software developers though an open structure is provided by the component adaptation and generation engine.

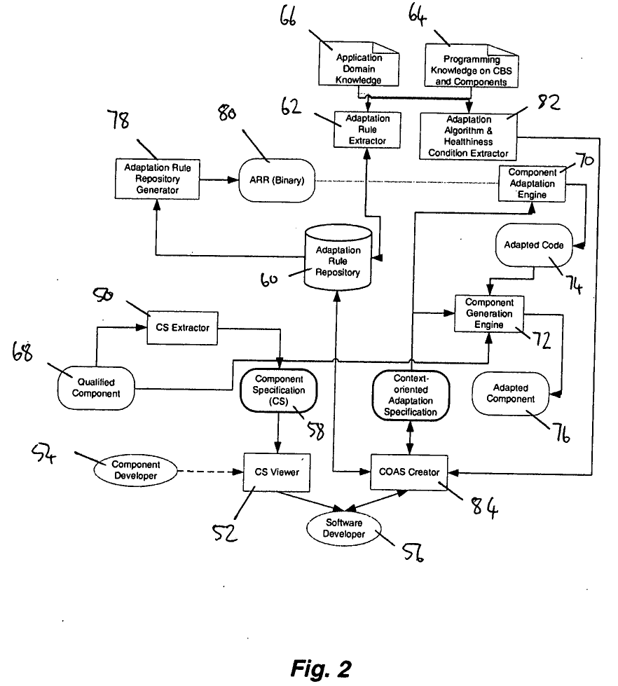

The process of FIG. 1 is enabled by a suitable adaptation tool. An embodiment of a suitable tool is shown in FIG. 2. This rule driven intelligent system aims to reduce the complexity and difficulty of component adaptation in order to distinguish between processes and components.

The architecture of the tool comprises three parts: component analysis, component adaptation and component generation.

In the tool, a context-oriented adaptation specification (COAS) is defined in an XML-based specification language. The whole generative component adaptation process is controlled by the built-in adaptation algorithms in the adaptation and generation engine, and directed by the COAS, provided as its input. The component specification (CS) is a specification of the interface and structure of a component in XML which is automatically extracted by the CS extractor 50 and displayed in the CS viewer 52.

A CS extractor 50 generates a component specification from the component's metadata, whilst a CS viewer 52 provides facilities to a component developer 54 or software developer 56 to view the component specification, giving the developers knowledge about the interface structure and logic process of the component. Component adaptation rules are stored in the adaptation rule repository 60. An adaptation rule is a formal definition of known rules of component adaptation which is extracted by an extractor component 62 from the programming knowledge 64 of components and CBS (Component-Based Systems) and application business domain knowledge 66. Adaptation tasks are implemented with a group of adaptation rule instances, which are instances of certain adaptation rules in the aimed adaptation context. The specification defines the aimed adaptation context and what, where and how the pre-qualified component 68 will be adapted. The pre-qualified component 68 has its component specification 58 extracted by the CS extractor 50. The component adaptation engine 70 informs the component generation engine 72 how to reassemble the component by providing it with the adapted code 74. The changed part of the adapted component 74, 76 will be integrated with the other unchanged part of the component 68, that is, the primitive code of the component 68.

The tools support dynamic and extendable component adaptation rules. The adaptation rule repository generator 78 maps the adaptation rules taken from the repository 60 into binary classes 80 to be accessed by the component adaptation engine 70. Software developers 66 may extract more adaptation rules from their business knowledge of their business domain or their programme knowledge of components and component based systems. These new rules are populated into the repository 60 through the adaptation rule extractor 62.

It may be more appropriate to model newly observed high level programming knowledge 64 or business domain knowledge 66 as new adaptation algorithms and insert them into the component adaptation engine 70. This process is supported with the adaptation algorithm extractor 82. However it will often be a manual process.

The interface between the software developer 56 and the tool comprises a COAS creator 84 and a CS viewer 52. The COAS creator accepts adaptation algorithms and healthiness condition and applies them when creating the correct COAS. To the software developer, adapting a component is the equivalent of composing an adaptation specification document. The adapted component can be automatically generated without further user interaction.

As different component models have their own implementation structure, the tool has been implemented on both .NET and Java platform. In either case, the tool comprises the following parts: 1) a CS extractor to abstract component specification from the pre-qualified components, that is, their binary code and metadata; 2) a CS viewer for software developers to gain understanding of the structure and behaviour a component interactively; 3) a context-oriented adaptation specification creator for software developers to create and edit adaptation specification; 4) an adaptation rule extractor for software developers to create and modify adaptation rules; 5) an adaptation rule repository to store, retrieve and maintain the adaptation rules; 6) a class library generator to automatically generate the class library of the adaptation rule repository; 7) a component adaptation engine to create the changed part of the component being adapted according to the context-oriented adaptation specification; and 8) a component generation engine to generate the adapted component in binary code automatically.

Generative component adaptation benefits from modern programming language frameworks, such as Java and .NET for example. The component, which is coded in a modern language framework, can be adapted at both run time and compile time. The adaptation of a pre-qualified component is implemented by replacing the changed part of the component with the intermediate code generated by the component adaptation engine. The component generation engine produces the binary adapted component by reassembling the component from its primitive code and changed code.

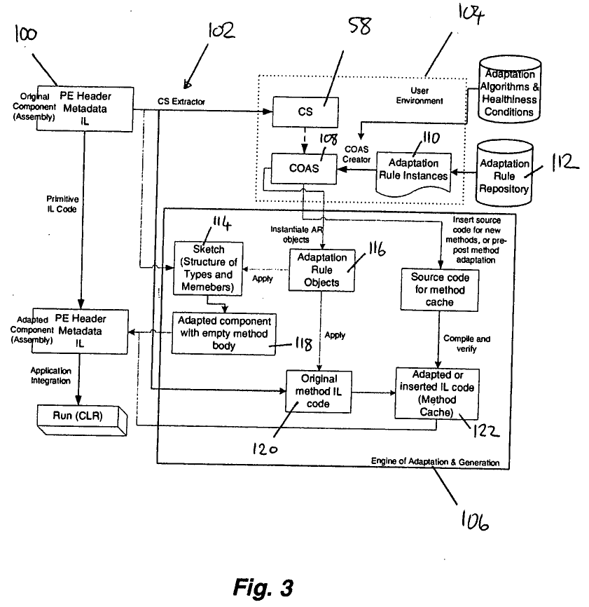

FIG. 3 illustrates the realisation of generative component adaptation process in .NET framework. In FIG. 3 like reference numerals as with FIG. 2 will be used where appropriate. With this realisation, an original component 100 in .NET assembly, which consists of the portable executable file format (PE) header, the Metadata and the intermediate language (IL) code, is adapted according to specific reuse context, and the adapted component is generated to include the three parts again, that is, the PE header, the Metadata, and the IL code. The adapted component is to be integrated into the target application.

The realisation comprises three parts: the CS extractor 102, the user environment 104 and the engine of adaptation and generation 106.

The CS extractor 102 extracts an outline specification of the structure and interface from the component's IL code and Metadata. The specification is then presented in the CS viewer 52, as part of the user environment 104.

The user environment 104 provides interactive facilities for a software developer to check the structure and behaviours of the component 100, and to compose the context-oriented adaptation specification 108 by selecting appropriate adaptation rules 110 from the adaptation rule repository 112 according to observed adaptation requirements. Adaptation algorithms and healthiness conditions are applied when creating the context-based adaptation specification.

The engine of adaptation and generation 106 follows the generic generative adaptation process depicted in FIG. 1 and FIG. 2, but with much specialisation for a .NET environment. The structure of the types and members of the component is first extracted (102) from the original component 100 and copied to create a sketch 114 of the original component, which comprises the types, classes and method signatures of the component but with empty method bodies. Adaptation rule instances specified in the COAS 108 are bound and instantiated into corresponding binary objects 116, which are called adaptation rule objects. Adaptation rule objects 116 are directly applicable to the original component 100 at binary code level. A part of the adaptation rule objects 116 are applied to adapt the sketch of the original component and the result is a new adapted component sketch 118 with empty method bodies. Other adaptation rule objects may be applied to adapt the bodies of relevant method(s) 120 of the original components. The adapted IL code 122 of the method body is kept in the method cache 122. If an adaptation action involves inserting a new method or a piece of new code pre or post the original method body, the new method body or piece will be acquired from the COAS 108 in form of any .NET compliant source code. The new method body or piece is then kept in the method cache 122. In the next step, the source code in the method cache is compiled into IL code 120 and verified for correctness.

In the last step of generative adaptation, the engine 106 integrates the adapted component sketch 118 with the adapted or inserted method body or pieces of body 122. That is, if the IL code in the method cache is the body of a new method, then insert it into the corresponding method in the sketch; if the IL code in the method cache is a piece of new code of a method body, then insert it into the relevant method at either the beginning or the rear of the method body. For other unchanged parts of the component, the engine just simply copies the primitive IL code into the new component. A new metadata will be created from the adapted IL code of the component.

In summary, only the changed parts of the original component are replaced in its adapted version. The final stage of component generation is to emit new binary formatted .NET component.

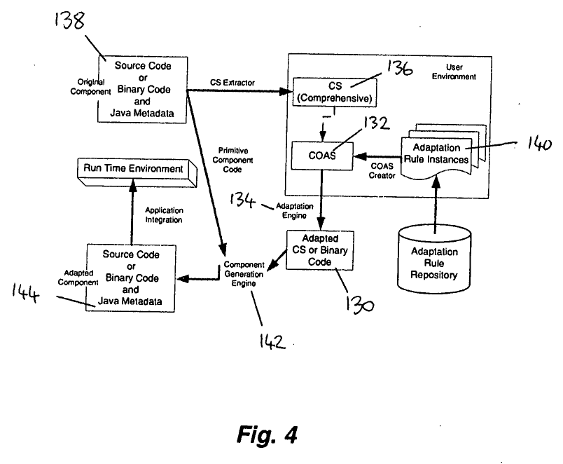

FIG. 4 illustrates the realisation of generative component adaptation process on a Java platform. The implementation of the generative component adaptation is slightly different on different platforms, as the existing component models are different.

On the Java platform, component adaptation may happen at either source code or binary code level.

At source code level, the component adaptation engine supports modification of XML-based component specification and emits a new component specification of the adapted component, that is, the adapted CS 130. In the first step, a context-oriented adaptation specification 132 is parsed and bound in to the component adaptation engine 134. Then the component adaptation engine 134 modifies the component specification 136 of the original component 138 according to the adaptation rule instance 140 in the context-oriented adaptation specification 132. Finally, the adapted component specification 130 is emitted as a new XML formatted CS.

For source code level adaptation, the CS 136 of the component 138 needs to be very detailed to contain the coding detail, which is called a comprehensive CS. The component generator 142 first converts the adapted comprehensive CS 130 of the changed part of the component into Java source code, and then it integrates the changed part of code with the primitive code of other unchanged part. The final product of the component generator is the adapted component 144 in Java source code.

For binary code level adaptation, instead of .NET IL code and Metadata, in the Java component model Java Virtual Machine binary code and Java Metadata are used as the counterpart techniques, such as Java Meta Data Interface from Sun Microsystems and Annotation from Java EE 5 platform. Other binary code level refactoring techniques may be used to support the implementation of the generative component adaptation process as well, for example, Java Byte Code Engineering Library.

At binary code level adaptation, the CS 136 of the component is an outline specification of the component's structure and interface, and it contains no code detail. The component adaptor uses technique(s) such as Java Byte Code Engineering Library, to adapt the component's binary code according to the adaptation rule instances specified in the context-oriented adaptation specification. The component generation engine generates the final component, which comprises its JVM binary code and Java Metadata, by integrating the changed part and unchanged part of binary code.

Annotations are a new feature, originally introduced in Java 2 Platform, Standard Edition (J2SE) 5.0. They are a form of metadata with a very simple syntax and recognizable because they begin with a leading ampersat (@). Annotations are generally used to embed in a program data that would otherwise be furnished in a side file.

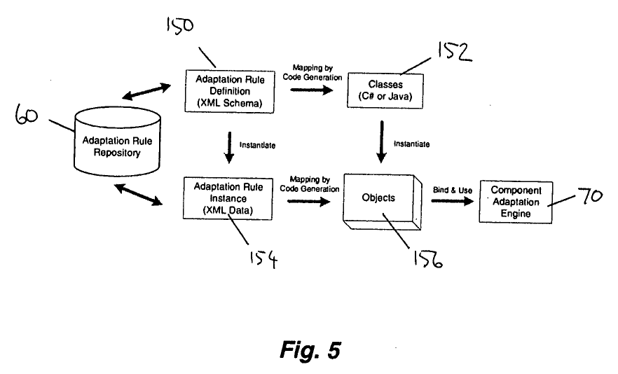

FIG. 5 illustrates the automatic binding and application of adaptation rules. Adaptation rule repository supports the reuse of adaptation knowledge at lower control level, i.e., adaptation rules and their instances, and even the whole or part of a context-oriented adaptation specification. The adaptation rule repository (ARR) is an asset repository that tracks and manages the adaptation rules that can be reused in future component adaptation process.

The life cycle of the operation of ARR involves four stages: 1) creating of component adaptation rules with the adaptation rule extractor 62; 2) storing of component adaptation rules in the repository system 60; 3) binding of component adaptation rules into binary classes 80; 4) referencing component adaptation rules in the component adaptation and generation engine 70,72 by importing their classes.

With an XML data-binding technique, a series of classes can be generated to reflect the data model defined in adaptation rules. Instances of adaptations rules can be bound into the tool automatically as objects derived from the adaptation rule classes. Then the component adaptation engine will use these objects to carry out component adaptation straightaway. A new adaptation rule may be extracted from domain knowledge and added into the repository.

With the auto-binding, a component adaptation rule 150 is mapped into a class 152 of component adaptation rule objects, and component adaptation rule instances 154 are mapped into object-oriented programming objects 156 dynamically. The application of component adaptation rule instances are archived by passing messages into active methods and triggering the methods in the objects. With the auto-binding, the engine of component adaptation and generation works independently to the change of adaptation rules. The adaptation rule changing will trigger rebinding the rules to the component adaptation and generation engine.

The auto-binding mechanism comprises a schema compiler which translates component adaptation rules into a set of schema-specific classes with appropriate access and mutation methods, a data marshalling framework which supports the marshalling and unmarshalling between XML formatted adaptation specification and graphs of interrelated instances of both existing and schema-derived classes.

During the compilation of adaptation types, XML formatted component adaptation rules are compiled into Java or C# classes. The Java or C# classes, compiled from XML formatted adaptation rules, can be directly applied by the component adaptation and generation engine.

The adaptation rule's marshalling/unmarshalling establishes conversion between annotating classes and adaptation rules. XML schema will define the translation between an adaptation action and an instance of the annotated class. It is used to associate adaptation rule instances with particular objects in the component adaptation and generation engine.

In summary, it can be seen that the methods and tools of the present invention provide many advantages as compared with existing component-based development methods and tools.

The present invention contributes to component adaptation and integration. The approach and its corresponding apparatus reduce the development cost and time to market of the constructed component-based systems through smoother reuse of available software components, and meanwhile improve the quality and efficiency of the component-based systems due to the elimination of mismatches in component interface and behaviour.

Compared with other existing technologies, the unique competitive edge of the approach and its apparatus is that it helps to achieve deep component adaptation and smooth component composition with little code overhead in the adapted components and the target system. Another competitive edge gained is the high automation in adaptation and integration process.

Adaptation rules are dynamic and process oriented, and provide the basis for the COAS, which comprises a context description rather than merely a use-case scenario. This approach enables generative adaptation with low code overhead, a deep adaptation of a type never before seen, and adapted components that are of high quality and correctness.

Various improvements and modifications and improvements can be made to the above without departing from the scope of the invention. In particular it is to be envisaged that the invention can be used in other software platforms than the .NET and Java platforms.

1. A method of adapting a software component comprising:
extracting a component specification comprising binary code and metadata from a first component;
creating a context-oriented adaptation specification;
adapting at least part of the first component in accordance with the context-oriented adaptation specification and an adaptation rule; and
generating an adapted component on the basis of the adapted and un-adapted parts of the first component.

2. The method of claim 1, further comprising the step of creating an adaptation rule.

3. The method of claim 1, wherein the adaptation rule is chosen from a selection of predetermined adaptation rules.

4. The method of claim 2, wherein said adaptation rule is automatically triggered when a chosen adaptation is required; and said adaptation rule performs an adaptation algorithm to yield one or more resultant adaptations.

5. The method of claim 4, wherein said adaptation algorithm is stored in a repository and is called by the adaptation rule.

6. The method of claim 1, wherein the first component is selected according to a pre-qualification process depending on system requirements including system architecture, functionality and quality attributes.

7. The method of claim 1, wherein the adaptation rules are selected from a repository.

8. The method of claim 7, wherein the repository has an open structure.

9. The method of claim 1, wherein adaptation rules are created on the basis of programming knowledge on CBS and components or from application domain knowledge.

10. The method of claim 7, wherein component adaptation rules are bound into binary classes of component adaptation rule objects.

11. The method of claim 1, wherein the step of adapting a component is checked against healthiness conditions which a component must meet for correct operation.

12. The method of claim 11, wherein an alert is generated to a software developer/user if a healthiness condition is breached by a proposed adaptation.

13. The method of claim 1, wherein healthiness conditions are created on the basis of programming knowledge on CBS and components or from application domain knowledge.

14. The method of claim 1, wherein a dependency graph is generated which illustrates the effects of an adaptation on other components or on other parts of the same component.

15. The method of claim 1, wherein the generated adapted component is validated against the proposed context-oriented adaptation specification before being finally approved for use.

16. The method of claim 1, being adapted for a .NET platform.

17. The method of claim 16, wherein the component specification comprises the component's IL code and metadata.

18. The method of claim 16 wherein a sketch of the first component is created with the types, classes and method signatures of the first component but with empty method bodies.

19. The method of claim 18, wherein adaptation rule objects are applied to adapt the bodies of the relevant methods of adapted components.

20. The method of claim 16, wherein an adapted component sketch is integrated with adapted or inserted method body or pieces of body in order to create the adapted component.

21. The method claim 1, being adapted for a JAVA platform.

22. The method of claim 21, wherein component adaptation is carried out at source code level.

23. The method of claim 22, wherein both the extracted and the adapted component specification is in XML format.

24. The method of claim 23, wherein component adaptation is carried out at binary code level.

25. The method of claim 24, wherein the component specification comprises the component's JVM binary code and Java metadata.

26. The method of claim 25, wherein the component specification comprises an outline specification of the component's structure and interface.

27. The method of claim 24, wherein Java Byte Code Engineering Library used to adapt the component's binary code according to adaptation rule instances specified in the context-oriented adaptation specification.

28. A tool for generating an adapted component comprising:
means for extracting a component specification from a first component;
means for creating and/or editing a context-oriented adaptation specification;
means for adapting at least part of the first component in accordance with the context-oriented adaptation specification and an adaptation rule;
means for generating an adapted component on the basis of the adapted and un-adapted parts of the first component.

29. The tool of claim 28, further comprising an adaptation rule extractor for the creation and editing of adaptation rules.

30. The tool of claim 28, further comprising an open-structured adaptation rule repository.

31. The tool of claim 28, further comprising a class library generator for automatically generating the class library of the adaptation rule repository.

32. The tool of claim 28, further comprising a component specification (CS) viewer tool for navigating the structure of the component.

33. The tool of claim 32, wherein the CS viewer tool displays dependency graphs showing interdependencies among components and/or adaptation rule instances.

34. The tool of any of claim 28, adapted for the performance of the method comprising the steps of:
extracting a component specification comprising binary code and metadata from a first component;
creating a context-oriented adaptation specification;
adapting at least part of the first component in accordance with the context-oriented adaptation specification and an adaptation rule; and
generating an adapted component on the basis of the adapted and un-adapted parts of the first component.

35. A computer program product comprising the tool of claim 28.
